(19) United States
(12) Patent Application Publication
(10) Pub. No.: US 2017/0171602 A1
(43) Pub. Date: Jun. 15, 2017

(54) METHOD AND ELECTRONIC DEVICE FOR CONTROLLING THREE STREAM VIDEO PLAY

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiang QU, Beijing (CN)

(21) Appl. No.: 15/244,907

(22) Filed: Aug. 23, 2016

Related U.S. Application Data
(63) Continuation of application No. PCT/CN2016/088945, filed on Jul. 6, 2016.

(30) Foreign Application Priority Data
Dec. 10, 2015 (CN) 201510908772.X

(51) Int. Cl. H04N 21/431; H04L 29/08; H04N 21/439; H04N 21/482; H04N 21/438; H04L 29/06; H04N 21/61

(52) U.S. Cl. CPC H04N 21/4312; H04L 65/60; H04L 65/4076; H04L 67/104; H04N 21/6125; H04N 21/4826; H04N 21/4383; H04N 21/439

(57) ABSTRACT

According to illustrative embodiments, the present disclosure relates to methods and electronic devices for controlling three stream video play, which are used for playing video contents of a main play flow in a play window on a mobile terminal screen, and meanwhile, playing a sound of the main play flow video. Exemplary implementations may perform the operation to play/stop the sound of the main play flow, and change a sound playing state of the main play flow. Meanwhile, the video content in the main play flow can be switched by playing a sound of the subsidiary play flow, thereby quickly and effectively switching the program of the main play flow, controlling the sound of the main play flow, and associating switching of the program in the main play flow with the sound control.

### CROSS REFERENCE TO RELATED APPLICATIONS

This application is a continuation of International PCT Application No. PCT/CN2016/088945, with an international filing date of Jul. 6, 2016 (attached hereto as an Appendix), and which claims benefit/priority to Chinese Patent Application CN 201510908772.X filed on Dec. 10, 2015 with the State Intellectual Property Office of China, titled “METHOD AND SYSTEM FOR CONTROLLING THREE STREAM VIDEO PLAY”, all of which are incorporated herein by reference in entirety

### BACKGROUND

Field

The present disclosure relates to the field of multimedia control, and in particular, to a method and an electronic device for controlling three stream video play.

Description of Related Information

P2P is an abbreviation of Peer to Peer, which represents a new network structure under a user broadband environment, and has no central server or has a weak central server, unlike the traditional Client/Server mode. Compared with the traditional C/S mode, P2P has advantages of capable of fully utilizing storage space, CPU and broadband resources of the user, and having very low operation and maintenance costs.

The streaming media technology is to, simply speaking, transmit multimedia files on a network using a streaming technology. However, the streaming technology is a network transmission technology to place continuous image and sound information having subjected to compression processing on a website server, such that the user is enabled to watch and listen while downloading, without waiting for the entire compressed file to be downloaded to his/her own machine completely. The P2P streaming media technology realizes live broadcast of the stream media using the P2P technology, and the typical application includes live broadcast of video and/or audio, IP-TV or the like, such as on-line broadcast of Olympic Games, Spring Festival Gala, Celebrity Interview, etc.

The network TV is a video service to transmit video flows using Internet. As for the current intelligent mobile terminal, although it realizes that screens of a plurality of video programs can be displayed at the intelligent mobile terminal simultaneously, the programs are played taking a certain video program as a main play flow. When it is required to switch the main play flow to play the programs, there is no quick and effective switch manner, and meanwhile, there is no quick and effective method for controlling the sound of the programs in the main play flow.

### OVERVIEW OF SOME ASPECTS OF THE PRESENT DISCLOSURE

For such and other purpose(s), the present disclosure provides a method and an electronic device for controlling three stream video play, thereby realizing to quickly and effectively switch the main play flow to play programs and control the sound of the programs in the main play flow.

According to a first aspect, the embodiment of the present disclosure based on the above purpose provides a method for controlling three stream video play, including:
playing and displaying three stream video contents in three play windows divided from a same display device simultaneously during a playing process of three stream video play;
among the three stream, one way of flow being a main play flow, and the other two ways of videos being subsidiary play flows;
displaying a sound control switch in each play window of the three stream, and when a trigger operation for the sound control switch is received,
further determining, if it is decided that a currently triggered operation for the sound control switch is for the main play flow, a current sound setting state of main play flow video content, setting a sound of the main play flow video content in an OFF state if it is in an ON state, or setting the sound of the main play flow video content in an ON state if it is in an OFF state; and
setting, if it is decided that the currently triggered operation for the sound control switch is for the subsidiary play flow, the subsidiary play flow as the main play flow, setting a sound of the subsidiary play flow video content in an ON state, meanwhile, setting the previous main play flow as the subsidiary play flow, or setting the sound of the previous main play flow video content in an OFF state.

According to a second aspect, the embodiment of the present disclosure based on the above purpose further provides a non-transitory computer-readable storage medium storing executable instructions that, when executed by an electronic device with a touch-sensitive display, cause the electronic device to: play and display three stream video contents in three play windows divided from a same display device simultaneously during a playing process of three stream video play, wherein among the three stream, one way of video is a main play flow, and the other two ways of videos are subsidiary play flows; display a sound control switch in each play window of the three stream, and when a trigger operation for the sound control switch is received, further determine, if it is decided that a currently triggered operation for the sound control switch is for the main play flow, a current sound setting state of main play flow video content, set a sound of the main play flow video content in an OFF state if it is in an ON state, or set the sound of the main play flow video content in an ON state if it is in an OFF state; and set, if it is decided that the currently triggered operation for the sound control switch is for the subsidiary play flow, the subsidiary play flow as the main play flow, set a sound of the subsidiary play flow video content in an ON state, meanwhile, set the previous main play flow as the subsidiary play flow, and set the sound of the previous main play flow video content in an OFF state.

According to a third aspect, the embodiment of the present disclosure provides an electronic device, comprising: at least one processor; and a memory communicably connected with the at least one processor for storing instructions executable by the at least one processor, wherein execution of the instructions by the at least one processor causes the at least one processor to: play and display three stream video contents in three play windows divided from a same display device simultaneously during a playing process of three stream video play, wherein among the three stream, one way of video is a main play flow, and the other two ways of videos are subsidiary play flows; display a sound control switch in each play window of the three stream, and when a trigger operation for the sound control switch is received, further determine, if it is decided that a currently triggered operation for the sound control switch is for the main play flow, a current sound setting state of main play flow video content, set a sound of the main play flow video content in an OFF state if it is in an ON state, or set the sound of the main play flow video content in an ON state if it is in an OFF state; and set, if it is decided that the currently triggered operation for the sound control switch is for the subsidiary play flow, the subsidiary play flow as the main play flow, set a sound of the subsidiary play flow video content in an ON state, meanwhile, set the previous main play flow as the subsidiary play flow, and set the sound of the previous main play flow video content in an OFF state.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of one embodiment of the method for controlling three stream video play of the present disclosure;

FIG. 2 is a structure schematic diagram of one embodiment of the system for controlling three stream video play of the present disclosure; and

FIG. 3 is a specific schematic flowchart of one embodiment of the method for controlling three stream video play of the present disclosure.

FIG. 4 is a schematic diagram of the hardware structure of the electronic device used to execute the method for controlling three stream video play provided in the embodiment of the present disclosure.

### DETAILED DESCRIPTION OF ILLUSTRATIVE IMPLEMENTATIONS

In order to make various objects, technical solutions and/or advantages of the prevent disclosure more apparent, the prevent disclosure will be described clearly below in conjunction with the specific embodiments and with reference to the drawings.

As one embodiment, the present disclosure provides a method for controlling three stream video play, which is applied to a display device with a touch screen, the method including: playing and displaying three stream video contents in three play windows divided from a same display device simultaneously during a playing process of three stream video play, wherein among the three stream, one way of video flow is a main play flow, and the other two ways of video flows are subsidiary play flows; wherein, in an initial state, one way of video flow located at the left-most of the play window among the three stream is deemed as the main playing video flow in default.

A sound control switch is displayed in each play window of the three stream, and when a trigger operation for the sound control switch is received, it is further determined a current sound setting state of the main play flow video content if it is decided that the sound control switch, of which a currently triggered operation is performed, is for the main play flow. If it is in an ON state, a sound of the main play flow video content is set in an OFF state; if it is in an OFF state, the sound of the main play flow video content is set in an ON state. If it is decided that the sound control switch, which is currently triggered, is for the subsidiary play flow, the subsidiary play flow is set as the main play flow, a sound of the subsidiary play flow video content is set in an ON state, meanwhile, the previous main play flow is set as the subsidiary play flow, and the sound of the previous main play flow video content is set in an OFF state. In this way, switching between the main play flow and the subsidiary play flow may be associated with controlling of the sound played/stopped, thereby quickly and effectively switching the main play flow and the subsidiary play flow.

Furthermore, the user may also set a state in which three stream videos can be played simultaneously as a state in which only one-way flow video is played, i.e., merge the three stream video play windows. During the process to play one-way flow video, a size of the video play window can be adjusted to obtain better video experiences. If the operation to merge the three stream video play windows is received, the current playing state of the main play flow video content is maintained and the display device is controlled to cancel display for the play window of the subsidiary play flow. Thus, merely one-way flow video play content is displayed on the display device of the mobile terminal.

As an optional solution, the process of the three stream video play further includes: acquiring the three stream video contents, storing acquired three stream video content data in a corresponding video cache area, reading the three stream video play content data from the cache area and playing the read three stream video play content data.

During a playing process of the three stream video, highlight the play window of the main play flow, and emphatically display the color of the sound control switch button in the main play flow window, thereby enabling the user to obtain better visual experience effects.

In addition, a program list is optionally displayed in a display area other than the three play windows on the display device, and when a rolling operation instruction is received, the program list in the display area is controlled to roll. In this way, the favorite programs set by the user in advance can be conveniently and quickly searched for. The three play windows are fixed to suspend above the program list, which do not roll with rolling of the program list, such that the user can watch the video program while searching for the favorite programs.

Video icons are displayed in the program list, that is, the program list is shown in a manner of arranging the video icons. After the first trigger operation is received, a first touch operation is recognized. If the first trigger operation is a long-press operation for a single video icon, a second trigger operation is further received and determined. If the second trigger operation is to drag the video icon to one of the video play windows, the video content corresponding to the video icon is played in the video play window. Through this operation, it is convenient for the user to quickly watch the video programs wanting to watch, via the play window of the three stream video.

When the playing state of the video in the play window is stop playing, the playing start control switch is displayed in the play window, and when the trigger instruction for the playing start control switch is received, the video in the window which has received the trigger instruction is continued to be played.

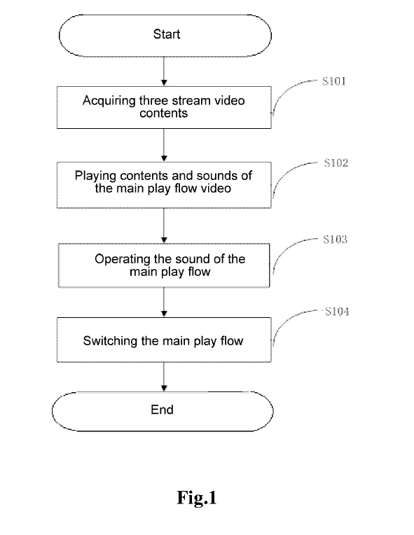

As one embodiment of the present disclosure, as shown in FIG. 1, it is a schematic flowchart of one embodiment of the method for realizing control of the three stream sound at the mobile terminal of the present disclosure.

The method for realizing control of the three stream sound at the mobile terminal, includes:

In step 101: three stream video contents are acquired: meanwhile, the acquired three stream video is stored in a corresponding video cache area;

In step 102: contents and sounds of the main play flow video are played: optionally, videos in the cache area are read and one of the three stream videos is selected as the main play flow, video contents are played in the main play flow in the play window on the mobile terminal screen, and meanwhile, the sound of the main play flow video is played;

In step 103: the sound of the main play flow is operated: during the process to perform the sound play/stop operation for the main play flow, the sound playing state of the main play flow is changed, while the position of the main play flow is not changed; and

In step 104: the main play flow is switched: when the sound of the subsidiary play flow video is played, the subsidiary play flow is switched to be the main play flow, and only one of the three stream videos is used as the main play flow.

Wherein, during the playing process of the three stream video play, three stream video contents are played and displayed in three play windows divided from the same display device, simultaneously. During the process to acquire the three stream video contents in step 101, video data in the three stream is independent from each other and is received at the same time, and the received video data is stored in the cache area corresponding to each video, respectively.

The process to acquire the three stream videos is further specifically divided into three steps: three stream video source management, three stream video medium transmission and three stream video medium cache.

The three stream video source management is to analyze a user instruction and obtain video source information of the three stream videos that the user needs to receive. Specifically, the three stream video source management is in charge of managing a synchronization mechanism between update and conversion of each flow video source and respective flow video sources. The three stream video medium transmission is to establish respective flow medium transmission channels corresponding to respective flow videos according to video source information of the three stream videos managed after the three stream video source. Specifically, the three stream video medium transmission is in charge of acquiring, in response to control of the three stream video source management, the three stream video data from the specific video source to the mobile terminal in a P2P transmission mechanism. The three stream video medium cache is to store video data, received by a plurality of flow medium transmission channels at the same time, in respective cache areas corresponding to respective channels. Specifically, the three stream video medium cache is to perform cache management for the multi-way video data which is acquired to the local, and locally display the video data in cooperation with the video display.

The content and sound of the main play flow video are played in step 102, which specifically is as follows: the video windows having the same number as the cache area are provided by three stream in accordance with the predetermined specification and layout, the video data is read from respective cache areas corresponding to respective video windows and the video data is displayed using the provided video windows. When the user uses the three stream to play the video, the mobile terminal will deem one way of flow as the main play flow in default, plays the video content in the play window of the main play flow, and meanwhile, plays the sound of the video played in the window.

During the sound operation of the main play flow in step 103, the operation to play/stop the sound of the played video is performed by a sound control key on the video play window. As the sound control key on the main play flow video window, it has a bright color and a showy vision. The video of the main play flow in step 102 is in a playing state and the sound is also in a playing state, the operation to stop the sound is performed for the video of the main play flow, and the video in the play window of the main play flow is continued to be played. However, the sound of the video cannot be played, and meanwhile, the sound of the video of other ways of the play flow cannot be played, either. The sound of the main play flow video is stopped, and the position of the main play flow video does not change, i.e., the play flow whose sound is stopped still is the main play flow. The operation to play the sound can be performed for the main play flow whose sound is closed. During the process from stopping the sound of the main play flow video to playing the sound of the main play flow video, the position of the main play flow still does not change. That is, the main play flow for which the operation to play the sound is performed still is the main play flow.

During the switching operation of the main play flow in step 104, when the user wants to watch the video program in other video flows, i.e., when the user needs to switch the subsidiary play flow as the main play flow, he or she can switch the play flow as the main play flow only needing to play the sound of the subsidiary play flow video. Only one way of flow among the three stream is the main play flow, i.e., only the sound of one way of video flow can be played.

As another embodiment of the present disclosure, when the user watches the video using the mobile terminal and starts three stream video play, the video display device establishes respective flow medium transmission channels corresponding to respective flow videos while receiving the operation to start playing. When the medium transmission channel is successfully established, the three stream video contents are acquired from the network, the video file is received by the medium transmission channel, the acquired three stream video is stored in the corresponding video cache area, the video in the cache area is read and one of the three stream is selected as the main play flow, and the video in the play window of the main play flow is played. Generally, one way of flow video at the left side is selected as the main play flow, the video content of the main play flow is played in the play window on the mobile terminal screen, and the sound of the main play flow video is played. Meanwhile, the color of the sound control key in this way of the video flow window is showy. That is, the color of the sound control icon is showy, so as to clearly show the window in which the video is playing to the user.

When the user performs the volume control operation for the mobile device, it is decided whether the operation is in a video area of the main play flow or in a video area of the subsidiary play flow. If the operation is in the video area of the main play flow, it is further determined a video volume state in the main play flow area, and the sound control function of the three stream indicates as display of the volume control key in the video play window. If the video volume is in an ON state, the state of the video volume is set as an OFF state, and the current flow is silent. The effect of showy color of the sound control key in this way of the window is remained, and other flows are also in a silent state. If the video volume is in an OFF state, the state of the video volume is set in an ON state. If the volume control operation performed for the mobile device by the user is in the video area of the subsidiary play flow, the subsidiary play flow is operated to play the video sound of the subsidiary play flow, and the flow to be operated currently is voiced. The color of the sound control key in this way of the window is showy, and the sound of the previous main play flow is stopped, such that the current way changes to the main play flow.

When the state of the flow is played in one way of video, a size of the video play window can be adjusted, so as to bring better video experience effects for the user. If the operation that the user slides down is received at this time, the video content of the main play flow among the three stream is played in one way of video play flow. The position of the video play window in one way of video play flow does not change, and the video icons in the program list roll along the direction of the sliding operation, thereby facilitating the user to search for the video icon that is set as the favorite program in advance.

When the user's operation for the sound key in a state where one way of video flow is played is received, since the video content in the main play flow is played in one way of video play flow, there are two kinds of cases for the sound operation, i.e., if the sound is stopped by operating the sound key, the sound of one way of video play flow is stopped, but the video content of the main play flow is still played; if the sound is played by operating the sound key, the sound of one way of video play flow is output, but the video content of the main play flow is still played. Moreover, the two kinds of states can be mutually converted.

It returns to the three stream state by sliding, i.e., the operations to play/stop the sound and switch the main play flow can be performed for the three stream video play. At this time, the position of the main play flow and the state of the video sound are unchanged, and the above-mentioned operation steps can be repeatedly performed, thereby making the user to obtain better video experiences.

As another embodiment of the present disclosure, the three stream video play can be changed to one-way video play flow playing by the sliding operation. When the three stream video play is changed to one-way flow video play, the current main play flow video content is played in the one-way video play flow, and meanwhile, the sound of the video in the main play flow is played. The play window of the one-way video play flow is located at the most left of the mobile terminal screen, the current playing state of the main play flow video content is maintained, and the display device is controlled to cancel display for the play window of the subsidiary play flow. The sliding operation is a sliding gesture from right to left in the horizontal direction. When it is required to change the one-way video play flow to three stream playing, the one-way video play flow can be re-changed to a three stream playing mode merely needing to perform the sliding operation on the screen of the mobile terminal from left to right in the horizontal direction, and at this time, the play window of the subsidiary play flow is re-displayed.

As another embodiment of the present disclosure, the three stream video play is to drag the selected video icon to an arbitrary play window among the three stream by long-pressing the video icon in the program list, and thus play the video content corresponding to the video icon. When the user presses on the mobile terminal screen for a long time, a pressure will be detected in a corresponding area on the mobile terminal screen and the video icon in the pressed video window is selected. The video icon is deemed to be selected in default all the time as long as the finger of the user does not leave the screen. The user can drag the selected video icon to an arbitrary play window among the three stream by long-pressing the screen of the mobile terminal with the finger and performing the sliding operation.

As another embodiment of the present disclosure, when the video contents in the three stream are stopped to be played, a playing start mark is displayed at the bottom right of the video play window, and the video can be restarted to be played by clicking the playing start mark.

As another aspect of the present disclosure, there is further provided a system for realizing control of the three stream sound at the mobile terminal.

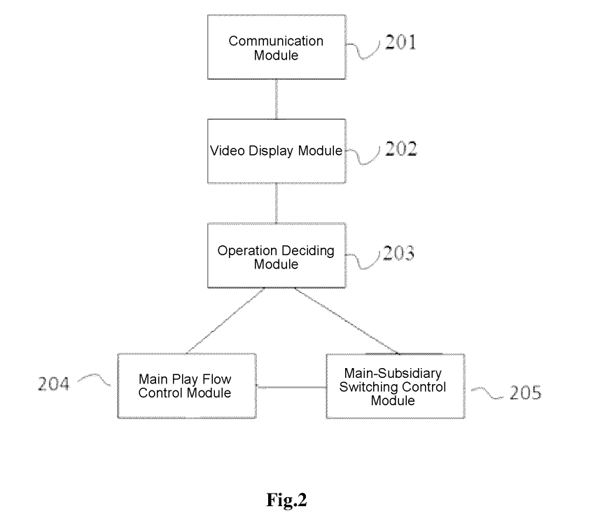

FIG. 2 is a structure schematic diagram of one embodiment of the system for realizing control of the three stream sound at the mobile terminal of the present disclosure, including:

A video display module 202 is configured to simultaneously play and display of three stream video contents in three play windows divided from the same display device during the playing process of the three stream video play, display a program list including video icons in an area other than the three play windows, display a sound control switch in each play window of the three stream, and when the three stream video is stopped playing, display a continuous playing control key.

An operation deciding module 203 is configured to decide, when the trigger operation for the sound control switch is received, whether the trigger operation for the sound control switch is an operation for the main play flow or an operation for the subsidiary play flow, decide whether the user's operation is in a window of the main play flow or in a window of the subsidiary play flow, and decide a selecting and sliding operation of the user.

A main play flow control module 204 is configured to determine, when the operation deciding module determines that a currently triggered operation for the sound control switch, is for the main play flow, the current sound setting state of the main play flow video content, set a sound of the main play flow video content in an OFF state if it is in an ON state, set the sound of the main play flow video content in an ON state if it is in an OFF state, and in an initial state, play the sound of the video deeming as the main play flow in default.

A main-subsidiary switching control module 205 is configured to determine, when the operation deciding module decides that the sound control switch, which is currently triggered, is for the main play flow, the current sound setting state of the main play flow video content, set a sound of the main play flow video content in an OFF state if it is in an ON state, set the sound of the main play flow video content in an ON state if it is in an OFF state. Furthermore, the system further includes a communication module 201, which is configured to acquire three stream video contents and store acquired three stream video in a corresponding video cache area.

During the process to acquire the three stream video contents by the communication module 201, video data in the three stream is independent from each other and is received at the same time, and the received video data is stored in the cache areas corresponding to respective videos, respectively.

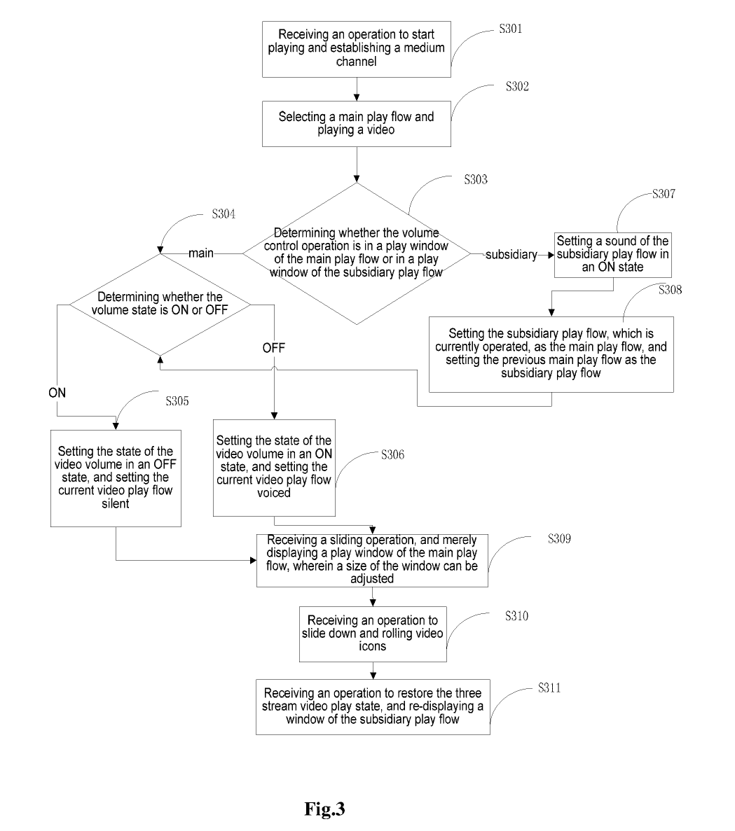

FIG. 3 is a specific schematic flowchart of one embodiment of the method for realizing control of the three stream sound at the mobile terminal of the present disclosure based on the system, including:

In step 301: when the user watches the video using the mobile terminal and starts three stream video play, and when the operation deciding module 203 receives the operation to start playing performed for the mobile terminal by the user, the communication module 201 establishes a medium transmission channel between the three stream video and the network, so as to acquire the video data.

In step 302: the communication module 201 acquires the three stream video contents by receiving the video data via the medium transmission channel, and stores acquired three stream video data in a corresponding video cache area. The video display module 202 reads the video data in the cache area and selects one way among the three stream as the main play flow, and plays the video in the play window of the main play flow, wherein the generally played video is the favorite video set by the user in advance, and the favorite program set by the user in advance has a heart-shaped sign on the video icon or is ranked at a front position.

The window at the left side is conventionally selected to play the main play flow. The video display module 202 plays the video content in the main play flow in the play window of the main play flow on the mobile terminal screen, and meanwhile, the main play flow control module 204 plays the sound of the main play flow video. Moreover, the video display module 202 emphatically display the color of the sound control key in this way of window, and emphatically display the window in which the main play flow video is playing to the user, e.g. Highlight a frame of the window of the main play flow video.

In step 303: when the user performs the volume control operation for the mobile device, the operation deciding module 203 decides whether the operation is in a play window of the main play flow or in a play window of the subsidiary play flow. If the operation is in the play window of the main play flow, step 304 is performed; if the volume control operation performed for the mobile device by the user is in the play window of the subsidiary play flow, the procedure advances to step 307.

In step 304: the main play flow control module 204 further determines a video volume state in the play window of the main play flow. If the video volume is in an ON state, the procedure advances to step 305; if the video volume is in an OFF state, the procedure advances to step 306.

In step 305: the main play flow control module 204 sets the state of the video volume in an OFF state, and sets the current video flow silent. The video display module 220 retains the effect of the showy color of the sound control key in this way of window, and meanwhile, keeps other flows in a silent state.

In step 306: the main play flow control module 204 sets the state of the video volume in an ON state, and sets the current video play flow voiced. The video display module 220 retains the effect of the showy color of the sound control key in this way of window, and meanwhile, keeps other flows in a silent state.

The procedure advances to the operation in step 309 after carrying out the operations in steps 305 and 306.

In step 307: the main-subsidiary switching control module 205 sets the video sound of the subsidiary play flow in an ON state, and meanwhile, the procedure advances to step 308.

In step 308: the video flow currently to be operated is sounded, the video display module 202 emphatically displays the color of the sound control key in this way of window, and changes this way of video play flow to the main play flow. Meanwhile, the main-subsidiary switching control module 205 stops the sound of the previous main play flow. When the operation deciding module 203 receives that the user operates the main play flow, the procedure advances to step 304, and such function is continued to be realized by the main play flow control module 204. The determination in step 304 can still be performed for the main play flow in step 308, so as to perform the operations in steps 305 and 306 for the main play flow in step 308.

In step 309: when the operation to slide from right to left by the user is received, the video display module 202 merely displays the play window of the main play flow, i.e., it is one-way video play flow. At the time, a size of the video play window can be adjusted to bring better video experience effects for the user.

In step 310: the video display module 202 displays the main play flow among the three-way video play flow, and the position of the play window in one-way video play flow is unchanged. When the operation that the user slides one-way video play flow down is received, the video display module 202 displays the video icons in the program list to roll along the direction of the sliding operation, thereby facilitating the user to search for the video icon that is set as the favorite program in advance.

In step 311: when the operation to slide from left to right by the user is received, the operation deciding module 203 determines that the operation is an operation to return to the three-way video play flow by sliding. The video display module 202 displays the state played in the three-way video play flow, and re-displays the subsidiary play flow window. Meanwhile, the user can perform the operation in step 303 for the three stream video play. At this time, the position of the main play flow and the state of the video sound are unchanged, the play window of the main play flow restores to an its original size, and the restored play window is non-adjustable. The user can repeat the above operation steps, so as to obtain better video experiences.

The embodiment of the present disclosure further provides a terminal, including a processor and a memory for storing an instruction executable by the processor, wherein the processor is configured to:
three stream video contents are played and displayed in three play windows divided from the same display device simultaneously during a playing process of three way flow video playing, wherein among the three stream, one way of video is a main play flow, and the other two ways of videos are subsidiary play flows;
a sound control switch is displayed in each play window of the three stream, and when a trigger operation for the sound control switch is received,
if it is decided that the currently triggered operation for the sound control switch is for the main play flow, a current sound setting state of the main play flow video content is further determined, a sound of the main play flow video content is set in an OFF state if it is in an ON state, and the sound of the main play flow video content is set in an ON state if it is in an OFF state; and
if it is decided that the currently triggered operation for the sound control switch is for the subsidiary play flow, the subsidiary play flow is set as the main play flow, and a sound of the subsidiary play flow video content is set in an ON state, meanwhile, the previous main play flow is set as the subsidiary play flow, and the sound of the previous main play flow video content is set in an OFF state.

The embodiments of the present disclosure further provide a non-transitory computer-readable storage medium storing executable instructions that cause to perform the method for controlling three stream video play provided in any of the method embodiments.

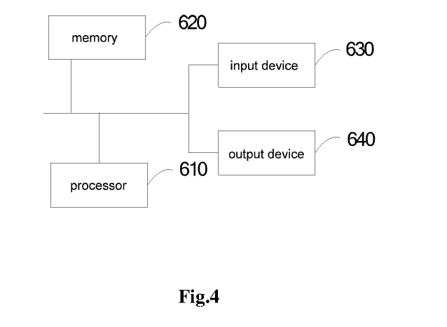

FIG. 4 is a schematic diagram of the hardware structure of the electronic device used to execute the method for controlling three stream video play provided in the embodiment of the present disclosure. As shown in FIG. 4, the device includes:

One or more processors 610 and a memory 620. FIG. 4 illustrates one processor 610 as an example.

The device that executes the method for controlling three stream video play may further include an input device 630 and an output device 640.

The processor 610, the memory 620, the input device 630 and the output device 640 may be connected with each other through bus or other means. FIG. 6 illustrates bus connection as an example.

As a non-transitory computer readable storage medium, the memory 620 may be configured to store non-transitory software program, non-transitory computer executable program and modules, such as program instructions/modules corresponding to the method for controlling three stream video play according to the embodiments of the disclosure (for example, the video display module 202, the operation deciding module 203, the main play flow control module 204 ant the main-subsidiary switching control module 205, as illustrated in FIG. 2). By executing the non-transitory software program, instructions and modules stored in the memory 620, the processor 610 may perform various functional applications of the server and data processing, that is, the method for displaying watermark according to the above mentioned embodiments.

The memory 620 may include a program storage area and a data storage area, wherein, the program storage area may be stored with the operating system and applications which are needed by at least one functions, and the data storage area may be stored with data which is created according to use of the device for controlling three stream video play. Further, the memory 620 may include a high-speed random access memory, and may further include non-transitory memory, such as at least one of disk memory device, flash memory device or other types of non-transitory solid state memory device. In some embodiments, optionally, the memory 620 may include memory provided remotely from the processor 610, and such remote memory may be connected with the device for controlling three stream video play through network, the examples of the networks may include but not limited to internet, intranet, LAN (Local Area Network), mobile communication network or combinations thereof.

The input device 630 may receive inputted number or character information, and generate key signal input related to the user settings and functional control of the device for controlling three stream video play. The output device 640 may include a display device such as a display screen.

The above one or more modules may be stored in the memory 620, when these modules are executed by the one or more processors 1110, the method for controlling three stream video play according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console , E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and include several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for controlling three stream video play, which is applied to a terminal, the method comprising:
playing and displaying three stream video contents in three play windows divided from a same display device simultaneously during a playing process of three stream video play, wherein among the three stream, one way of video is a main play flow, and the other two ways of videos are subsidiary play flows;
displaying a sound control switch in each play window of the three stream, and when a trigger operation for the sound control switch is received, further
determining, if it is decided that a currently triggered operation for the sound control switch is for the main play flow, a current sound setting state of main play flow video content, setting a sound of the main play flow video content in an OFF state if it is in an ON state, or setting the sound of the main play flow video content in an ON state if it is in an OFF state; and
setting, if it is decided that the currently triggered operation for the sound control switch is for the subsidiary play flow, the subsidiary play flow as the main play flow, setting a sound of the subsidiary play flow video content in an ON state, meanwhile, setting the previous main play flow as the subsidiary play flow, and setting the sound of the previous main play flow video content in an OFF state.

2. The method for controlling three stream video play according to claim 1, further comprising:
maintaining, if an operation to merge three stream video play windows is received, a current play content in a video play window of the main play flow, and meanwhile, cancelling display for a play window of the subsidiary play flow.

3. The method for controlling three stream video play according to claim 1, wherein the playing process of the three stream video further comprises:
acquiring the three stream video contents, storing acquired three stream video content data in a corresponding video cache area, reading the three stream video play content data from the cache area and playing the read three stream video play content data.

4. The method for controlling three stream video play according to claim 1, further comprising:
highlighting the play window of the main play flow, and emphatically displaying a sound control switch button in the main play flow window.

5. The method for controlling three stream video play according to claim 1, wherein:
a program list is displayed in a display area other than the three play windows on the display device; and
when a rolling operation instruction is received, the program list in the display area is controlled to roll, wherein the three play windows are fixed to suspend above the program list.

6. The method for controlling three stream video play according to claim 5, wherein:
video icons are displayed in the program list, and when a first trigger operation is received, a second trigger operation is further received and determined if the first trigger operation is a long-press operation for a video icon; and if the second trigger operation is to drag the video icon to one of the video play windows, the video content corresponding to the video icon is played in the video play window.

7. The method for controlling three stream video play according to claim 5, wherein:
when a playing state of the video in the play window is stop playing, a playing start control switch is displayed in the play window, and when a trigger instruction for the playing start control switch is received, the video in the window which has received the trigger instruction is continued to be played.

8. A non-transitory computer-readable storage medium storing executable instructions that, when executed by an electronic device with a touch-sensitive display, cause the electronic device to:
play and display three stream video contents in three play windows divided from a same display device simultaneously during a playing process of three stream video play, wherein among the three stream, one way of video is a main play flow, and the other two ways of videos are subsidiary play flows;
display a sound control switch in each play window of the three stream, and when a trigger operation for the sound control switch is received, further
determine, if it is decided that a currently triggered operation for the sound control switch is for the main play flow, a current sound setting state of main play flow video content, set a sound of the main play flow video content in an OFF state if it is in an ON state, or set the sound of the main play flow video content in an ON state if it is in an OFF state; and
set, if it is decided that the currently triggered operation for the sound control switch is for the subsidiary play flow, the subsidiary play flow as the main play flow, set a sound of the subsidiary play flow video content in an ON state, meanwhile, set the previous main play flow as the subsidiary play flow, and set the sound of the previous main play flow video content in an OFF state.

9. The non-transitory computer-readable storage medium according to claim 8, wherein the executable instructions further cause the electronic device to:
maintain, if an operation to merge three stream video play windows is received, a current play content in a video play window of the main play flow, and meanwhile, cancel display for a play window of the subsidiary play flow.

10. The non-transitory computer-readable storage medium according to claim 8, wherein the executable instructions further cause the electronic device to:
acquire the three stream video contents, store acquired three stream video content data in a corresponding video cache area, read the three stream video play content data from the cache area and play the read three stream video play content data.

11. The non-transitory computer-readable storage medium according to claim 8, wherein further cause the electronic device to:
highlight the play window of the main play flow, and emphatically display a sound control switch button in the main play flow window.

12. The non-transitory computer-readable storage medium according to claim 8, wherein the executable instructions further cause the electronic device to:
display a program list in a display area other than the three play windows on the display device; and
when a rolling operation instruction is received, control the program list in the display area to roll, wherein the three play windows is fixed to suspend above the program list.

13. The non-transitory computer-readable storage medium according to claim 12, wherein the executable instructions further cause the electronic device to:
display video icons in the program list, and when a first trigger operation is received, further received a second trigger operation and determined if the first trigger operation is a long-press operation for a video icon; and if the second trigger operation is to drag the video icon to one of the video play windows, display the video content corresponding to the video icon in the video play window.

14. An electronic device, comprising:
at least one processor; and
a memory communicably connected with the at least one processor for storing instructions executable by the at least one processor, wherein execution of the instructions by the at least one processor causes the at least one processor to:
play and display three stream video contents in three play windows divided from a same display device simultaneously during a playing process of three stream video play, wherein among the three stream, one way of video is a main play flow, and the other two ways of videos are subsidiary play flows;
display a sound control switch in each play window of the three stream, and when a trigger operation for the sound control switch is received, further
determine, if it is decided that a currently triggered operation for the sound control switch is for the main play flow, a current sound setting state of main play flow video content, set a sound of the main play flow video content in an OFF state if it is in an ON state, or set the sound of the main play flow video content in an ON state if it is in an OFF state; and
set, if it is decided that the currently triggered operation for the sound control switch is for the subsidiary play flow, the subsidiary play flow as the main play flow, set a sound of the subsidiary play flow video content in an ON state, meanwhile, set the previous main play flow as the subsidiary play flow, and set the sound of the previous main play flow video content in an OFF state.

15. The electronic device according to claim 14, wherein the at least one processor is further caused to:
maintain, if an operation to merge three stream video play windows is received, a current play content in a video play window of the main play flow, and meanwhile, cancel display for a play window of the subsidiary play flow.

16. The electronic device according to claim 14, wherein the at least one processor is further caused to:
acquire the three stream video contents, store acquired three stream video content data in a corresponding video cache area, read the three stream video play content data from the cache area and play the read three stream video play content data.

17. The electronic device according to claim 14, wherein the at least one processor is further caused to:
highlight the play window of the main play flow, and emphatically display a sound control switch button in the main play flow window.

18. The electronic device according to claim 14, wherein the at least one processor is further caused to:
display a program list in a display area other than the three play windows on the display device; and
when a rolling operation instruction is received, control the program list in the display area to roll, wherein the three play windows is fixed to suspend above the program list.

19. The electronic device according to claim 18, wherein the at least one processor is further caused to:
display video icons in the program list, and when a first trigger operation is received, further received a second trigger operation and determined if the first trigger operation is a long-press operation for a video icon; and if the second trigger operation is to drag the video icon to one of the video play windows, display the video content corresponding to the video icon in the video play window.

20. The electronic device according to claim 18, wherein the at least one processor is further caused to:
when a playing state of the video in the play window is stop playing, display a playing start control switch in the play window, and when a trigger instruction for the playing start control switch is received, continue to play the video in the window which has received the trigger instruction.
